(19) United States
(12) Patent Application Publication
(10) Pub. No.: US 2016/0134554 A1
(43) Pub. Date: May 12, 2016

(54) DELEGATED USER INTERFACE FOR RESOURCE CONSTRAINED DEVICE

(71) Applicant: Cisco Technology, Inc., San Jose, CA (US)

(72) Inventor: TOM DECKERS, Meer (BE)

(21) Appl. No.: 14/535,040

(22) Filed: Nov. 6, 2014

(51) Int. Cl. H04L 12/911

(52) U.S. Cl. CPC H04L 47/70

(57) ABSTRACT

In one embodiment, a method comprises receiving, at a resource constrained device, a first web page request generated by a user device; and returning to the user device, by the resource constrained device in response to the first web page request, a redirect address toward a server configured for providing a script for communicating with the resource constrained device.

### TECHNICAL FIELD

The present disclosure generally relates to providing a user interface for a resource constrained device.

### BACKGROUND

This section describes approaches that could be employed, but are not necessarily approaches that have been previously conceived or employed. Hence, unless explicitly specified otherwise, any approaches described in this section are not prior art to the claims in this application, and any approaches described in this section are not admitted to be prior art by inclusion in this section.

As the Internet of Things (IoT) proliferates, multitudes of new types of devices will be connected to the Internet. Many of these new devices can be resource constrained devices having limited storage, limited processing capability that typically are read only type sensor devices.

### BRIEF DESCRIPTION OF THE DRAWINGS

Reference is made to the attached drawings, wherein elements having the same reference numeral designations represent like elements throughout and wherein:

FIG. 1 illustrates an example system having an example apparatus for accessing an IoT device, according to an example embodiment.

FIG. 2 illustrates an example implementation of any one of the devices of FIG. 1, according to an example embodiment.

FIG. 3 illustrates an example method for an apparatus obtaining a delegated user interface from a user interface server, according to an example embodiment.

FIG. 4 illustrates an example method for an IoT device to redirect a user device to user interface server, according to an example embodiment.

FIG. 5 illustrates an example web browser comprised of an example user interface, according to an example embodiment.

### DESCRIPTION OF EXAMPLE EMBODIMENTS

### Overview

In one embodiment, a method comprises: receiving, at a resource constrained device, a first web page request generated by a user device; and returning to the user device, by the resource constrained device in response to the first web page request, a redirect address toward a server configured for providing a script for communicating with the resource constrained device.

In another embodiment, an apparatus comprises a network interface circuit, and a processor circuit. The network interface circuit is configured for receiving a first web page request generated by a user device, the apparatus implemented as a resource constrained device.

The processor circuit is configured for returning to the user device, in response to the first web page request, a redirect address toward a server configured for providing a script for communicating with the resource constrained device.

In another embodiment, logic is encoded in one or more non-transitory tangible media for execution by a machine, and when executed by the machine operable for: receiving, at a resource constrained device, a first web page request generated by a user device; and returning to the user device, by the resource constrained device in response to the first web page request, a redirect address toward a server configured for providing a script for communicating with the resource constrained device.

In another embodiment, a method comprises: transmitting, by a user device, a first web page request to a resource constrained device; receiving, by the user device, a redirect address from the resource constrained device and having been supplied based on the first web request; retrieving a script from a server based on the redirect address; transmitting, by the user device, a second request to the resource constrained device in response to executing the script retrieved from the server; and receiving, by the user device, data requested by the second request.

In another embodiment, an apparatus comprises a network interface circuit, and a processor circuit. The network interface circuit is configured for transmitting a first web page request to a resource constrained device, and further configured for receiving a redirect address from the resource constrained device and having been supplied based on the first web request. The processor circuit is configured for retrieving a script from a server based on the redirect address, the processor circuit further configured for generating and transmitting a second request to the resource constrained device in response to executing the script retrieved from the server. The network interface circuit further is configured for receiving data requested by the second request. In another embodiment, logic is encoded in one or more non-transitory tangible media for execution by a machine, and when executed by the machine operable for: transmitting, by a user device, a first web page request to a resource constrained device; receiving, by the user device, a redirect address from the resource constrained device and having been supplied based on the first web request; retrieving a script from a server based on the redirect address; transmitting, by the user device, a second request to the resource constrained device in response to executing the script retrieved from the server; and receiving, by the user device, data requested by the second request.

### DETAILED DESCRIPTION

Internet-of-Things (IoT) devices are manufactured with minimal hardware to minimize costs. Such devices can be referred to as “resource constrained”. Such IoT devices can provide a minimalistic web browser accessible user interface (UI), and/or provide an inflexible web browser accessible UI. Hence, such devices cannot provide a web browser accessible rich UI for configuration and operational purposes.

Particular embodiments enable a user device to access data from and/or configure an IoT device with a web browser (e.g., Chrome, Internet Explorer, Mozilla, Safari, etc.). The user device can be configured to send a web page request (e.g., HTTP) to the IoT device (e.g., via a URL). The IoT device can be configured to respond to the web page request by transmitting a redirect address (e.g., an HTTP redirect URL, a redirect Internet Protocol (IP) address) to the user device. The user device can be configured to respond to the redirect address by accessing a user interface server that is configured to provide a script to the user device. The user interface server is “delegated” to provide the script for the IoT device instead of the IoT device providing such a script. The user device can be configured to execute the script received from the user interface server to generate a delegated user interface (DUI) to graphically view data received from the IoT device and/or graphically configure the IoT device.

The IoT device can be configured as any number of devices that a manufacturer wants to make as small and/or cheap as possible, including such devices as a temperature sensing device, Wi-Fi router, print server, network attached storage (NAS) device, smart light bulb, smart thermostat, wearable activity tracker, health monitors, etc.

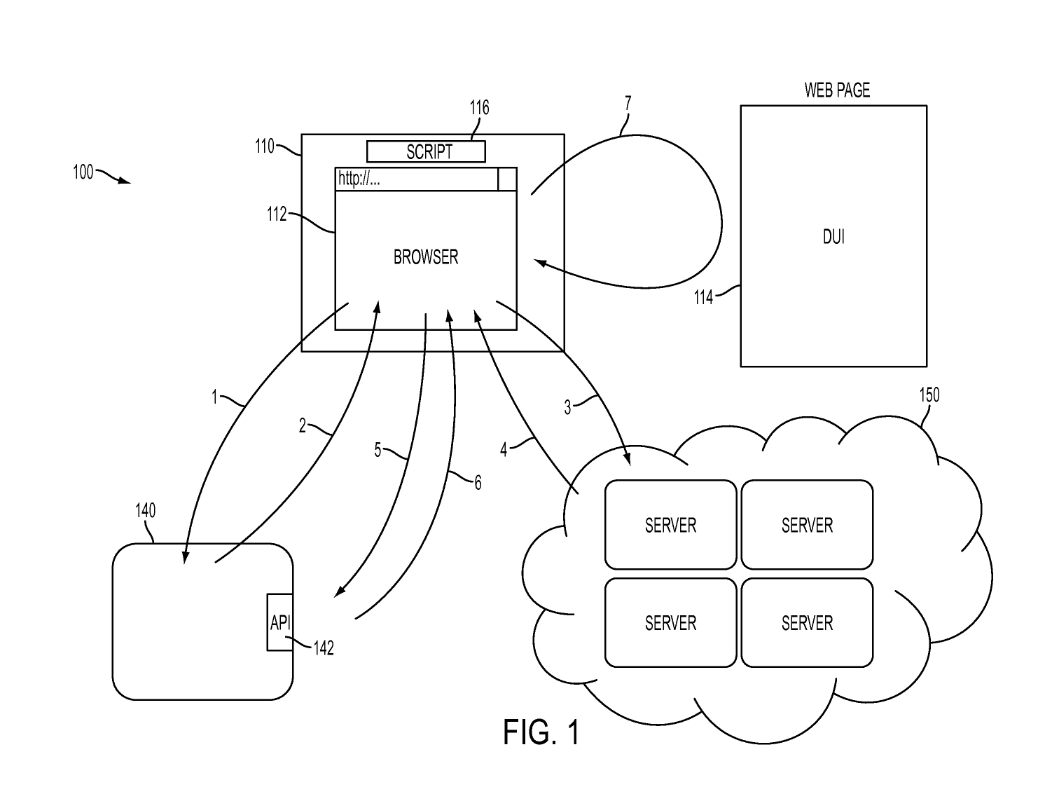

FIG. 1 illustrates an example system having an example apparatus for accessing an IoT device, according to an example embodiment. The apparatuses 110, 140, and 150, are physical machines (i.e., a hardware device) configured for implementing network communications with any of the other physical machines 110, 140, and 150, via the system 100.

A user device 110 can be configured to generate a web page request, via a web browser 112. The web page request can be output toward the IoT device 140. The IoT device 140 can be configured to respond to the web page request by outputting a redirect address. The user device 110 can respond to the redirect address by sending a redirected request, via the web browser 112, to access the user interface server 150.

The user interface server 150 can be configured to access, in response to the redirected request, a script database (not shown) to retrieve one or more scripts 116 (e.g., JavaScript (e.g., Jquery.js, Angular.js, Modemizr, User script) Cascading Style Sheets (CSS)) from the user interface server 150. The script database can store any number of scripts 116 for any number of IoT devices 140. The scripts 116 stored by the script database can be dynamically changed and/or provide a customized experience for individual user devices 110 (e.g., based on operating system, hardware configuration, hardware limitations, screen size, etc.). The user interface server 150 can be configured to transmit one or more scripts 116 to the user device 110. The user interface server 150 can be configured as a delegated source of scripts 116 for IoT devices 140.

The user device 110 can be configured to execute, via the web browser 112, the script 116 received from the user interface server 150. The script 116 can generate a DUI 114 in the web browser 112 executed by the user device 110. The DUI 114 can comprise one or more of, e.g., Hypertext Markup Language (HTML) pages, images, sounds, video, etc. The user device 110 can be configured to execute the script 116 to graphically configure the IoT device 140 and/or retrieve data stored by the IoT device 140. The script 116 can generate the DUI 114 on the web browser 112 to graphically display the data retrieved from the IoT device 140.

The IoT device 140 can comprise an API 142. The API 142 of the IoT device 140 can be a minimalistic embedded web server (e.g., no larger than 30-40 KB in size) with a basic Representational State Transfer (REST) API, such as GNU Libmicrohttpd. The IoT device 140 can be configured to execute instructions according to the API 142 to configure the IoT device 140 and/or control transmission of data requested from the IoT device 140. The API 142 can configure the IoT device 140 according to instructions received from the user device 110.

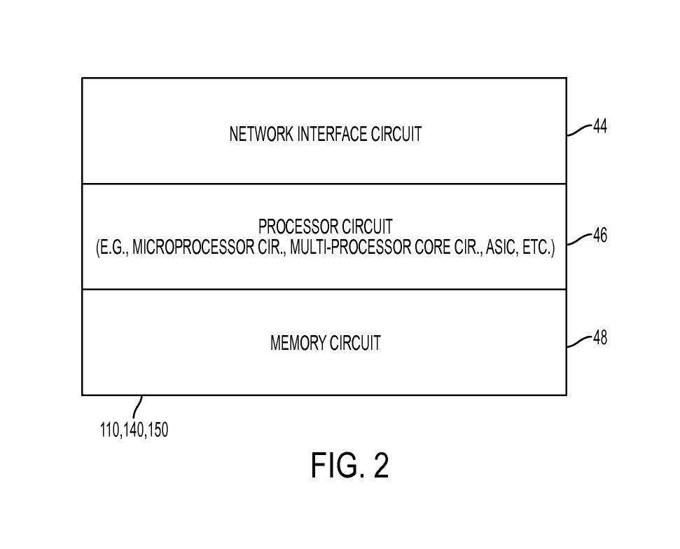

FIG. 2 illustrates an example implementation of any one of the devices 110, 140, and/or 150 of FIG. 1, according to an example embodiment.

Each apparatus 110, 140, and/or 150 can include a network interface circuit 44, a processor circuit 46, and a memory circuit 48. The network interface circuit 44 can include one or more distinct physical layer transceivers for communication with any one of the other devices 110, 140, and/or 150 according to the appropriate physical layer protocol (e.g., Wi-Fi, DSL, DOCSIS, 3G/4G, Ethernet, etc.) via any of the links (e.g., a wired or wireless link, an optical link, etc.), as appropriate. The processor circuit 46 can be configured for executing any of the operations described herein, and the memory circuit 48 can be configured for storing any data or data packets as described herein.

Any of the disclosed circuits of the devices 110, 140, and/or 150 (including the network interface circuit 44, the processor circuit 46, the memory circuit 48, and their associated components) can be implemented in multiple forms. Example implementations of the disclosed circuits include hardware logic that is implemented in a logic array such as a programmable logic array (PLA), a field programmable gate array (FPGA), or by mask programming of integrated circuits such as an application-specific integrated circuit (ASIC). Any of these circuits also can be implemented using a software-based executable resource that is executed by a corresponding internal processor circuit such as a microprocessor circuit (not shown) and implemented using one or more integrated circuits, where execution of executable code stored in an internal memory circuit (e.g., within the memory circuit 48) causes the integrated circuit(s) implementing the processor circuit to store application state variables in processor memory, creating an executable application resource (e.g., an application instance) that performs the operations of the circuit as described herein. Hence, use of the term “circuit” in this specification refers to both a hardware-based circuit implemented using one or more integrated circuits and that includes logic for performing the described operations, or a software-based circuit that includes a processor circuit (implemented using one or more integrated circuits), the processor circuit including a reserved portion of processor memory for storage of application state data and application variables that are modified by execution of the executable code by a processor circuit. The memory circuit 48 can be implemented, for example, using a non-volatile memory such as a programmable read only memory (PROM) or an EPROM, rotating disk, and/or a volatile memory such as a DRAM, etc.

Further, any reference to “outputting a message” or “outputting a packet” (or the like) can be implemented based on creating the message/packet in the form of a data structure and storing that data structure in a non-transitory tangible memory medium in the disclosed apparatus (e.g., in a transmit buffer). Any reference to “outputting a message” or “outputting a packet” (or the like) also can include electrically transmitting (e.g., via wired electric current or wireless electric field, as appropriate) the message/packet stored in the non-transitory tangible memory medium to another network node via a communications medium (e.g., a wired or wireless link, as appropriate) (optical transmission also can be used, as appropriate). Similarly, any reference to “receiving a message” or “receiving a packet” (or the like) can be implemented based on the disclosed apparatus detecting the electrical (or optical) transmission of the message/packet on the communications medium, and storing the detected transmission as a data structure in a non-transitory tangible memory medium in the disclosed apparatus (e.g., in a receive buffer). Also note that the memory circuit 48 can be implemented dynamically by the processor circuit 46, for example based on memory address assignment and partitioning executed by the processor circuit 46.

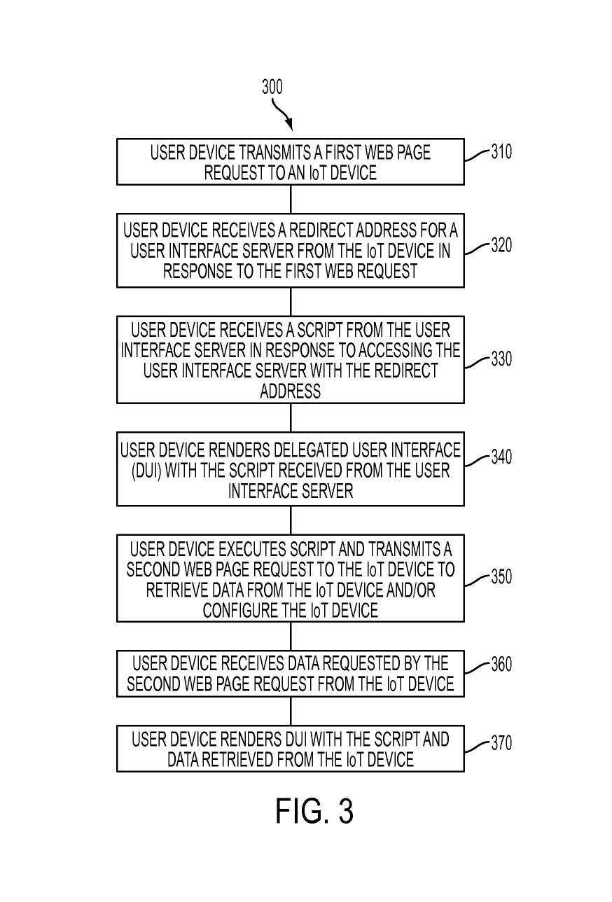

FIG. 3 illustrates an example method 300 for an apparatus 110 obtaining a delegated user interface from a user interface server 150, according to an example embodiment. The operations described with respect to any of the Figures can be implemented as executable code stored on a computer or machine readable non-transitory tangible storage medium (e.g., floppy disk, hard disk, ROM, EEPROM, nonvolatile RAM, CD-ROM, etc.) that are completed based on execution of the code by a processor circuit implemented using one or more integrated circuits; the operations described herein also can be implemented as executable logic (implemented using one or more integrated circuits) that is encoded in one or more non-transitory tangible media for execution (e.g., programmable logic arrays or devices, field programmable gate arrays, programmable array logic, application specific integrated circuits, etc.).

In addition, the operations described with respect to any of the FIGS. 1-5 can be performed in any suitable order, or at least some of the operations in parallel. Execution of the operations as described herein is by way of illustration only; as such, the operations do not necessarily need to be executed by the machine-based hardware components as described herein; to the contrary, other machine-based hardware components can be used to execute the disclosed operations in any appropriate order, or at least some of the operations in parallel.

Referring to operation 310 of FIG. 3, the user device 110 can be configured to transmit a first web page request, shown as communication #1 in FIG. 1. The first web page request can be transmitted in response to a user entering a URL into the web browser 112 of the user device 110 for accessing the IoT device 140. The user device 110 can be configured to transmit the first web page request to the IoT device 140 in response to the URL entered into the web browser 112. The user device 110 can receive in operation 320 a redirect address (e.g., an HTTPs redirect address) generated by the IoT device 140, shown as communication #2 in FIG. 1. The response including the redirect address can be received in response to the first web page request generated in operation 310. A location header can include the redirect address in of the response from the IoT device 140. The response can include data detailing the specific type of IoT device 140 being access by the user device 110. The web browser 112 of the user device 110 can respond to the redirect address by retrieving a script 116 (e.g., JavaScript) from the user interface server 150, shown as communication #3 in FIG. 1.

The user device 110 can be configured to receive in operation 330 the script 116 from the user interface server 150, shown as communication #4 in FIG. 1. The script 116 received from the user interface server 150 can correspond to the specific type of IoT device 140 being accessed by the user device 110. The script 116 can include instructions to interface with the API 142 of the IoT device 140 to access data stored on the IoT device 140 and/or configure the IoT device 140. The script 116 can generate the DUI 112 to include the data retrieved from the IoT device 140.

The user device 110 can be configured to render in operation 340 the DUI 114, shown as communication #7 in FIG. 1. The user device 110 can execute the script 116, via the web browser 112, received in operation 330 to render the DUI 114 on a display of the user device 110. The DUI 114 rendered by the user device 110 can provide a graphical interface to view the data retrieved from the IoT device 140 and/or configure the IoT device 140.

The user device 110 can be configured to transmit in operation 350 a second request, shown as communication #5 in FIG. 1. The script 116 received in operation 330 can generate the second request. The second request can be transmitted by the user device 110 to access data stored on the IoT device 140 and/or configure the IoT device 140.

The user device 110 can be configured to receive in operation 360 data requested from the IoT device 140, shown as communication #6 in FIG. 1. Dependent upon the type of IoT device 140 being accessed by the user device 110, the data requested can include, e.g., central processing unit (CPU) load, memory usage, temperature, light settings, heart rate, blood pressure, distance traveled, sensor information, configurable parameters, historical usage information, downtime information, uptime information, health information, etc.

The user device 110 can be configured to render in operation 370 the DUI 114, via the web browser 112, on a display of the user device 110, shown as communication #7 in FIG. 1. The user device 110 can be configured to execute the script 116 to render the DUI 114 to include a visual representation of data received from the IoT device 140 in operation 360. In some embodiments, the DUI 114 rendered by the user device 110 in operation 340 can be updated to include the data received from the IoT device 140 in operation 360. In some embodiments, the user device 110 can poll the IoT device 140 to automatically update the DUI 114 with updated data received from the IoT device 140.

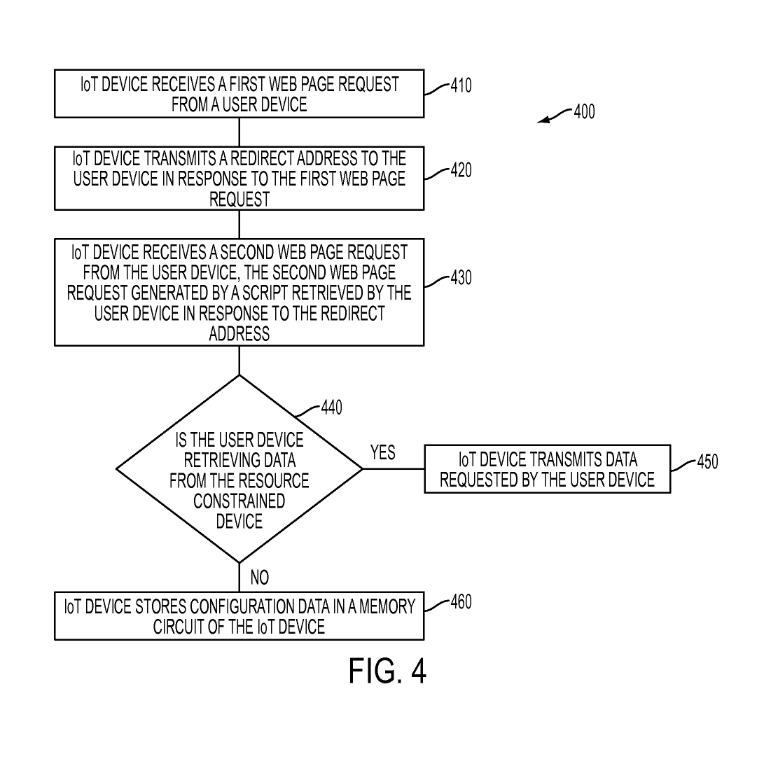

FIG. 4 illustrates an example method 400 for an IoT device 140 to redirect a user device 110 to user interface server 150, according to an example embodiment. As described in combination with respect to FIGS. 1 and 2, the IoT device 140 can be executed for example by processor circuit 46 of FIG. 2 and/or a logic circuit.

The IoT device 140 can be configured to receive in operation 410 a first web page request from the user device 110, shown as communication #1 in FIG. 1. The first web page request can be transmitted by the user device 110 in operation 310, discussed above.

The IoT device 140 can be configured to transmit in operation 420 a redirect address, shown as communication #2 in FIG. 1. The redirect address can be the redirect address described in operation 320 above. The application programming interface (API) 142 can comprise a minimalistic embedded web server. The API 142 of the IoT device 140 can retrieve the redirect address from the memory circuit 48 of the IoT device 140. The API 142 of the IoT device 140 can be configured to set a location header of a response message to the redirect address, as discussed above. The API 142 of the IoT device 140 can execute embedded web server functionality to transmit the response message comprising the redirect address to the user device 110.

In some embodiments, the IoT device 140 can be configured to set in operation 420 relevant Cross-Origin Resource Sharing (CORS) headers. CORS headers can allow devices in different network domains to establish communications while bypassing security measures. CORS headers can allow an IoT device 140 that is in a different domain than the user device 110 to communicate with the user device 110. Authentication for the IoT device 140 can be implemented as if the IoT device 140 were providing the DUI 114 to the user device 110. The user interface server 150 can be configured to set the script 116 (e.g., JavaScript) to establish CORS credentials prior to the user device 110 sending the second request to the IoT device 140.

The IoT device 140 can be configured to receive in operation 430 the second request, shown as communication #5 in FIG. 1. The second request can be transmitted to the IoT device 140 in operation 350, discussed above. The second request can include a request to retrieve data stored in the memory circuit 48 of the IoT device 140 and/or to configure the IoT device 140.

The IoT device 140 can be configured to determine a type of second request received in operation 430. The API 142 of the IoT device 140 can determine if the second request is a request for data or a request to configure the IoT device 140. If operation 430 determines that the second request is a request for data, operation 430 branches to operation 450. If operation 430 determines that the second request is not a request for data, operation 430 branches to operation 460.

The IoT device 140 can be configured to transmit in operation 450 data requested by the user device 110, shown as communication #6 in FIG. 1. The API 142 of the IoT device 140 can retrieve data requested and stored in the memory circuit 48 of the IoT device 140. The API 142 of the IoT device 140 can generate one or more data packets comprising the data requested. The network interface circuit 44 of the IoT device 140 can transmit the requested data from the IoT device 140 to the user device 110.

The IoT device 140 can be configured to store in operation 460 configuration data. The API 142 of the IoT device 140 can execute instructions to store configuration data received in operation 430 in the memory circuit 48 of the IoT device 140. In some embodiments, the API 142 of the IoT device 140 can store configuration data in pre-designated configuration registers in the memory circuit 48 of the IoT device 140. The configuration data can change operational parameters of the IoT device 140.

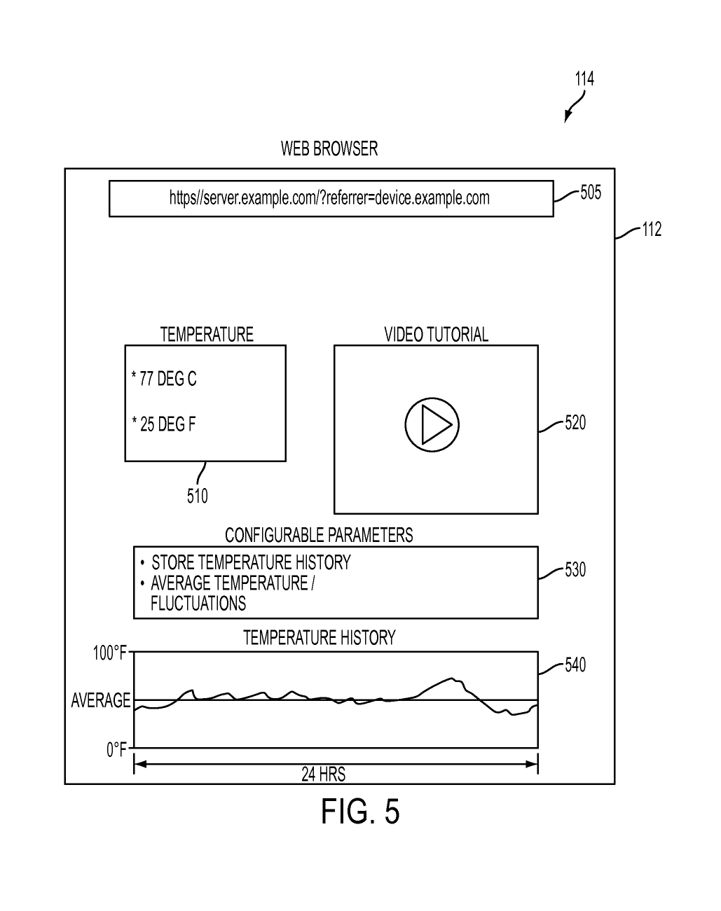

FIG. 5 illustrates an example web browser 112 comprised of an example user interface, according to an example embodiment. The web browser 112 is illustrated as displaying the DUI 114 for an IoT device 140 that is, e.g., a resource constrained temperature sensing device. The user device 110 can be configured to render in operations 340 and 370 discussed above the example DUI 114 comprising a URL entry box 505, a temperature box 510, a video tutorial box 520, a configurable parameters box 530, and a temperature history box 540.

The URL entry box 505 can display a user entered URL in operation 310 and an HTTP redirect URL received in operation 320.

The temperature box 510 can display temperature data received by the user device 110 in operation 360 from the IoT device 140.

The video tutorial box 520 can display a video for a user of the user device 110 illustrating how to, e.g., install the IoT device 140, configure the IoT device 140, calibrate the IoT device 140, navigate the DUI 114 for the IoT device 140, troubleshoot the IoT device 140, etc. The user device 110 can be configured to execute the script 116 to retrieve the video from the user interface server 150 (or any other server storing the video) and play the video for a user of the user device 110. In some embodiment, the user device 110 can execute video rendering capabilities built into the web browser 112 and/or the user device 110 to play the video for the user of the user device 110.

The configurable parameters box 530 can display parameters that can be modified on the IoT device 110 with the user device 110. For example, a user of the user device 110 can select to store a temperature history over a 24 hour period and average temperature fluctuations over the 24 hour period. In response to a user of the user device 110 selecting to store the temperature history over the 24 hour period, the user device 110 can be configured to transmit in operation 350 a second request to the IoT device 140. The second request can instruct the IoT device 140 to store temperature data recorded by the temperature sensor over the 24 hour period in the memory circuit 48 of the IoT device 140. The API 142 of the IoT device 140 can include a selectable feature to store temperature data for the 24 hour period. The second request can set a register in the memory circuit 48 of the IoT device 140 to turn on the feature to store temperature data for the 24 hour period. In response to a user of the user device 110 selecting to average temperature fluctuations over the 24 hour period, the processor circuit 46 of the user device 110 can be configured to calculate an average for the temperature data received from the resource constrained temperature sensing device and visually render the calculated average in the temperature history box 540.

In some embodiments, existing non-resource constrained devices can be updated to include the API 142. For example, a Wi-Fi router that is configured with a web server to transmit a UI to a user device 110 can be updated (e.g., firmware update) to instead comprise the API 142. The API 142 updated Wi-Fi router can then transit a redirect address to the user device 110, instead of a UI. The user device 110 can be configured to retrieve a DUI 114 from a user interface server 150 for the API 142 updated Wi-Fi router.

While the example embodiments in the present disclosure have been described in connection with what is presently considered to be the best mode for carrying out the subject matter specified in the appended claims, it is to be understood that the example embodiments are only illustrative, and are not to restrict the subject matter specified in the appended claims.

What is claimed is:

1. A method comprising:
receiving, at a resource constrained device, a first web page request generated by a user device; and
returning to the user device, by the resource constrained device in response to the first web page request, a redirect address toward a server configured for providing a script for communicating with the resource constrained device.

2. The method of claim 1, further comprising:
receiving, at the resource constrained device, a second request generated by the user device; and
responding to the second request by one or more of transmitting, by the resource constrained device, data requested by the second request to the user device, or configuring the resource constrained device.

3. The method of claim 1, further comprising executing an application programming interface (API) to perform the returning and the responding.

4. The method of claim 1, wherein the returning returns a Hypertext Transfer Protocol (HTTP) redirect address.

5. The method of claim 1, wherein the returning returns the redirect address toward the server configured for providing a JavaScript script for communicating with the resource constrained device.

6. An apparatus comprising:
a network interface circuit configured for receiving a first web page request generated by a user device, the apparatus implemented as a resource constrained device; and
a processor circuit configured for returning to the user device, in response to the first web page request, a redirect address toward a server configured for providing a script for communicating with the resource constrained device.

7. The apparatus of claim 6, wherein the processor circuit further is configured for responding to a second request, generated by the user device and received by the network interface circuit, by one or more of transmitting, by the resource constrained device, data requested by the second request to the user device, or configuring the resource constrained device.

8. The apparatus of claim 6, wherein the processor circuit is configured for executing an application programming interface (API) to perform the returning and the responding.

9. The apparatus of claim 6, wherein the processor circuit is configured for returning a Hypertext Transfer Protocol (HTTP) redirect address.

10. The apparatus of claim 6, wherein the processor circuit is configured for returning the redirect address toward the server configured for providing a JavaScript script for communicating with the resource constrained device.

11. Logic encoded in one or more non-transitory tangible media for execution by a machine and when executed by the machine operable for:
receiving, at a resource constrained device, a first web page request generated by a user device; and
returning to the user device, by the resource constrained device in response to the first web page request, a redirect address toward a server configured for providing a script for communicating with the resource constrained device.

12. A method comprising:
transmitting, by a user device, a first web page request to a resource constrained device;
receiving, by the user device, a redirect address from the resource constrained device and having been supplied based on the first web request;
retrieving a script from a server based on the redirect address;
transmitting, by the user device, a second request to the resource constrained device in response to executing the script retrieved from the server; and
receiving, by the user device, data requested by the second request.

13. The method of claim 12, further comprising transmitting, by the user device, a third request to the resource constrained device in response to execution of the script, the third web page request configuring the resource constrained device.

14. The method of claim 12, wherein the receiving the redirect address receives a Hypertext Transfer Protocol (HTTP) redirect address.

15. The method of claim 12, wherein the script is a JavaScript script.

16. An apparatus comprising:
a network interface circuit configured for transmitting a first web page request to a resource constrained device, and further configured for receiving a redirect address from the resource constrained device and having been supplied based on the first web request; and
a processor circuit configured for retrieving a script from a server based on the redirect address, the processor circuit further configured for generating and transmitting a second request to the resource constrained device in response to executing the script retrieved from the server;
the network interface circuit further configured for receiving data requested by the second request.

17. The apparatus of claim 16, wherein the processor is further configured for generating and transmitting a third web page request to the resource constrained device in response to execution of the script, the third web page request configuring the resource constrained device.

18. The apparatus of claim 16, wherein the receiving the redirect address receives a Hypertext Transfer Protocol (HTTP) redirect address.

19. The apparatus of claim 16, wherein the second request is generated by a JavaScript script.

20. Logic encoded in one or more non-transitory tangible media for execution by a machine and when executed by the machine operable for:
transmitting, by a user device, a first web page request to a resource constrained device;
receiving, by the user device, a redirect address from the resource constrained device and having been supplied based on the first web request;
retrieving a script from a server based on the redirect address;
transmitting, by the user device, a second request to the resource constrained device in response to executing the script retrieved from the server; and
receiving, by the user device, data requested by the second request.
